(19) United States
(12) Patent Application Publication
(10) Pub. No.: US 2008/0134807 A1
(43) Pub. Date: Jun. 12, 2008

(54) MOTORIZED PIPETTE

(76) Inventor: Yves-Andre May, Versailles (FR)

Correspondence Address: FOLEY & LARDNER LLP, 150 EAST GILMAN STREET, P.O. BOX 1497, MADISON, WI, 53701-1497, US

(21) Appl. No.: 11/944,024

(22) Filed: Nov. 21, 2007

Related U.S. Application Data
(63) Continuation of application No. PCT/EP2006/062566, filed on May 24, 2006.

(30) Foreign Application Priority Data
May 24, 2005 (FR) 0505207

(51) Int. Cl. F16H 21/44; B01L 3/02

(52) U.S. Cl. 73/864.01; 74/25

(57) ABSTRACT

A pipette is provided having a reduced operational vibration and noise and an increased operational accuracy. The pipette includes a body and a drive unit mounted within the body. The drive unit includes a motor, an operating rod configured for movement under control of the motor, a nut, and an elastic strip. The nut is mounted to the operating rod and is configured to allow translational movement of the operating rod with respect to the nut, but not to allow rotational movement of the operating rod with respect to the nut. The elastic strip is mounted to the nut and to the body to exert a rotational torque on the nut.

### CROSS-REFERENCE TO RELATED APPLICATIONS

This application is a continuation application of International Application No. PCT/EP2006/062566 filed on May 24, 2006, the entire contents of which is hereby incorporated by reference; which claims the benefit of French Patent Application No. 05/05207 that was filed May 24, 2005, the entire contents of which is hereby incorporated by reference.

### FIELD

The field of the disclosure relates generally to power operated pipettes used in laboratories for collecting liquid samples in a container and transferring them to another container.

### BACKGROUND

Motorized pipettes are known in the prior art. A plunger system of the pipette, which is housed in a lower portion of a pipette body, is actuated by means of an operating rod capable of moving in a longitudinal direction of the pipette body. The operating rod is moved as desired by the user by an actuator including a motor. An end of the operating rod is in contact with the plunger system. The plunger system is moved by a pushing action exerted by the operating rod during dispensing operations, in which the actuator moves the rod downward. The plunger system is moved by a spring during aspiration operations, in which the actuator moves the rod upward, and which rod remains in contact with the plunger system so as to control its movement. One disadvantage of the known motorized pipettes is that the movements of the operating rod are accompanied by vibrations and noises that are unpleasant for the user.

The main source of vibration and noise to be eliminated is that of the operating rod which includes a rotational movement that leads to vibrations when the operating rod moves. These vibrations are communicated to other parts of the pipette. In addition to the inconvenience to the user, these vibrations alter the precision of movement of the rod and contribute to limiting of the performance of the pipette due to the small translational movements of the operating rod. In addition, as they are transmitted to the plunger, they are capable of damaging the sealing in operation of the mobile system, in particular after numerous uses of the pipette due to the wear that they cause. Thus, what is needed is a system for significantly reducing and even eliminating these vibrations and noises.

### SUMMARY

In an exemplary embodiment, a pipette is provided having a reduced operational vibration and noise and an increased operational accuracy. The pipette includes, but is not limited to, a body and a drive unit mounted within the body. The drive unit includes a motor, an operating rod configured for movement under control of the motor, a nut, and an elastic strip. The nut is mounted to the operating rod and is configured to allow translational movement of the operating rod with respect to the nut, but not to allow rotational movement of the operating rod with respect to the nut. The elastic strip is mounted to the nut and to the body to exert a rotational torque on the nut.

In another exemplary embodiment, a drive unit of a device is provided. The drive unit includes, but is not limited to, a motor, an operating rod configured for movement under control of the motor, a nut, and an elastic strip. The nut is mounted to the operating rod and is configured to allow translational movement of the operating rod with respect to the nut, but not to allow rotational movement of the operating rod with respect to the nut. The elastic strip is mounted to the nut and configured to mount to a body of the device to exert a rotational torque on the nut.

Other principal features and advantages of the invention will become apparent to those skilled in the art upon review of the following drawings, the detailed description, and the appended claims.

### BRIEF DESCRIPTION OF THE DRAWINGS

Exemplary embodiments will hereafter be described with reference to the accompanying drawings, wherein like numerals denote like elements.

FIG. 1 shows a side cross-sectional view of a drive unit in a longitudinal direction of a motorized pipette in accordance with an exemplary embodiment.

FIG. 2 shows an enlarged view of a detail area II of FIG. 1.

FIG. 3 shows a cross sectional view along III-III of FIG. 2.

FIG. 4 shows a perspective, exploded view of FIG. 1.

### DETAILED DESCRIPTION

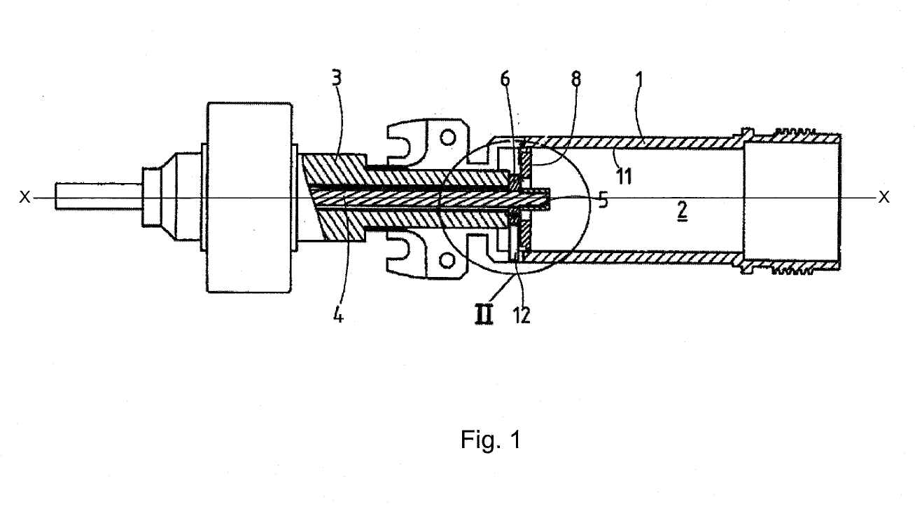

FIG. 1 shows a partial longitudinal cross-section of a pipette in accordance with an exemplary embodiment in which only the body of the pipette and its operating system are represented. A body 1 of the pipette encloses, in a lower portion 2 of its internal space, a mobile plunger system (not shown), which executes liquid aspiration and dispensation operations. In the internal space of its upper portion, the body 1 supports the operating system of the pipette, of which the essential parts are a motor and its screw-nut system, which will hereinafter be designated as a motor 3 for the purpose of simplification, and an operating rod 4 of which the motor 3 controls the movement along the longitudinal axis X-X of the pipette. Operating rod 4 may be terminated by an end piece 5 that provides contact between the operating rod 4 and the upper surface of the mobile system of which the operating rod 4 controls the downward movements during dispensation of the liquid and of which it stops the upward movements during aspiration of the liquid. The elements described above are conventional in a motorized pipette.

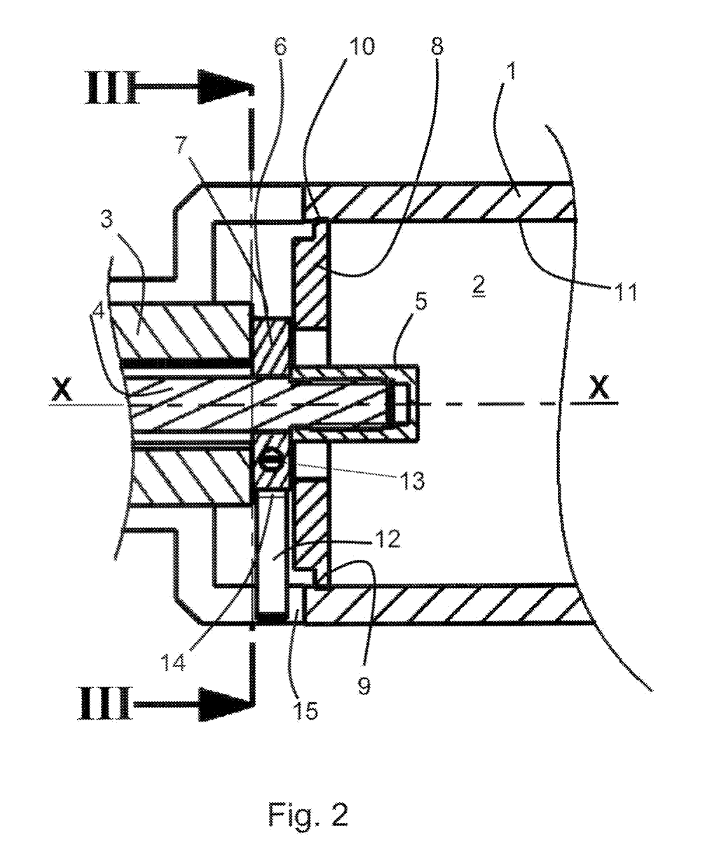

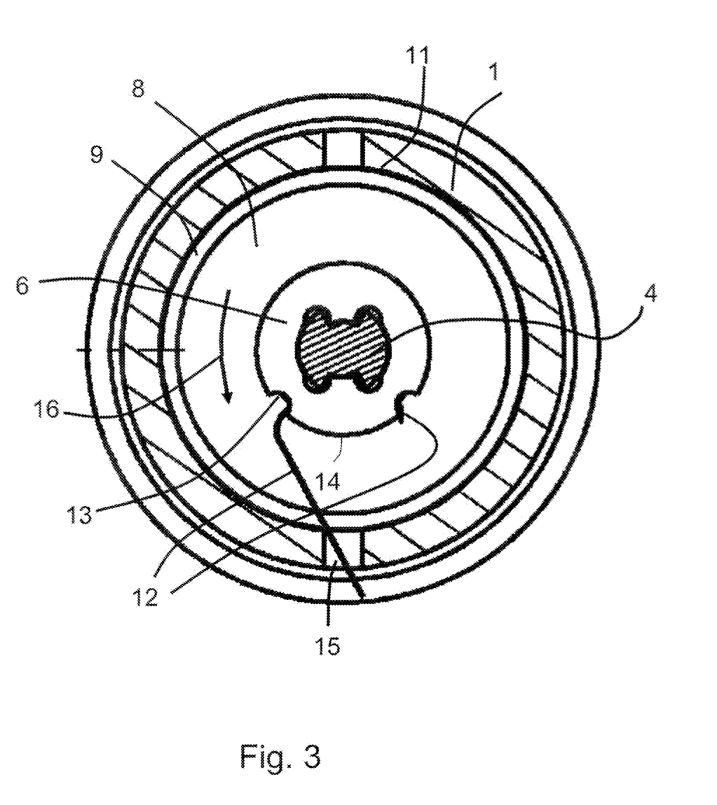

With reference to FIG. 3, the operating rod 4 does not have a strictly circular cross-section. Operating rod 4 is inserted into a central aperture of a nut 6, inside of which it can slide freely so as to exert its action on the mobile system of the pipette, but not turn due to the fact that the central aperture has a shape that, in cooperation with that of the cross-section of the rod 4, prevents such a rotation. When the pipette is assembled, the nut 6 is arranged between a lower end 7 of the motor 3 (or, more generally, the lower end of the portion fixed in translation of the operating system) and the upper surface of a support ring 8, with a slight functional play that allows for rotation of the nut 6 about the axis X-X. With reference to FIGS. 2 and 3, the support ring 8 has, on its periphery, an edge 9 that, when the pipette is assembled, is embedded in a corresponding groove 10 formed on an internal wall 11 of the body 1 of the pipette. In this way, the support ring 8 cannot move in translation along the axis X-X and limits downward movements of the nut 6 to those allowed by the aforementioned functional play. Similarly, the upward movements of the nut 6 are limited by the lower end 7 of the motor 3.

An elastic strip 12, forming a spring, of which a first end is hooked in an aperture 13 formed on a side wall 14 of the nut 6, and of which a second end is inserted into a recess 15 formed in the side wall of the body 1. After assembly of the pipette, the elastic strip 12 is in a preloaded state that causes it to constantly exert a torque on the operating rod 4 by means of the nut 6. This torque makes it possible to compensate for the rotational movement of the operating rod 4, in particular during movements imparted by the motor 3. In this way, it is possible to suppress the vibrations, the noise, and the imprecise movement of the operating rod 4, due to the existence of rotational movement in pipettes of the prior art, which lack such a rotational movement compensation device. The method shown for securing the elastic strip 12 to the nut 6 and the body 1 is, of course, merely one non-limiting example. Any other reliable method, preferably allowing for full disassembly of the pipette, may also be suitable. The rotational movement compensation device comprising the nut 6 and the elastic strip 12 described above is an exemplary embodiment. Other types of devices enabling such a rotational compensation also may be used.

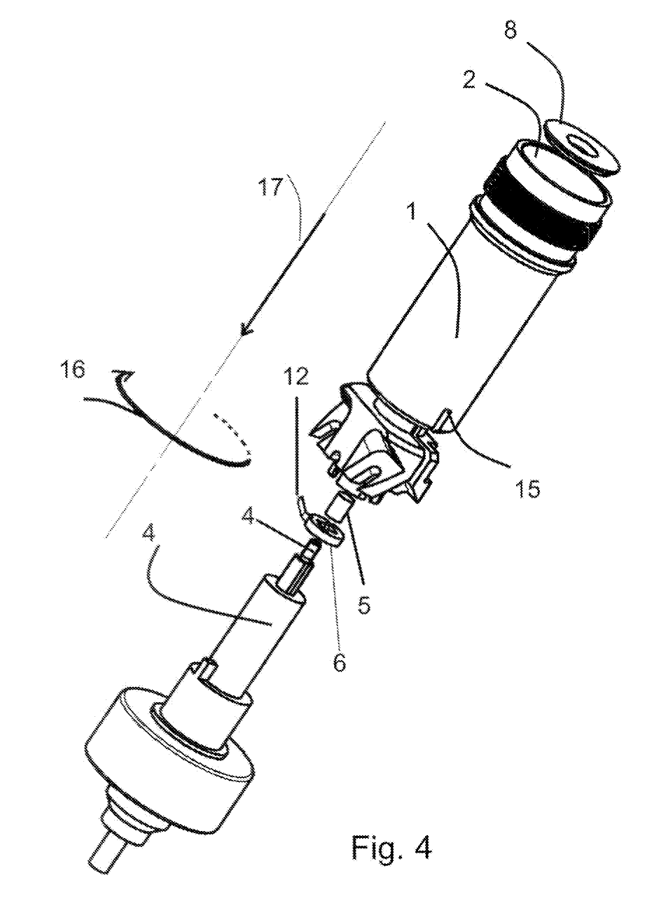

Advantageously, the torque exerted by the rotational movement compensation device is provided in the same direction as the stress imparted on the internal screw thread of the motor. In this way, the stress needed to be applied by the rotational movement compensation device is limited. Otherwise, this stress may be greater. Thus, in the example shown in FIGS. 3 and 4, where the screw thread of the motor is a right-hand thread, the torque exerted by the elastic strip 12 and the nut 6 is exerted along the arrow 16, i.e. in the counter-clockwise direction when the device is viewed as in FIG. 3. In FIG. 4, the arrow 17 designates the direction of the stress applied to the operating rod 4 by the lower portion of the pipette including the plunger system.

The device according to the invention can be applied to pipettes with a variety of types of operating systems, such as those comprising: a stepper motor having an integrated “rotation into translation” movement transformation system; a direct-current motor with an integrated linear system; an electric motor coupled to an independent screw-nut system, etc. In the example described and shown, the device for compensating for the rotational movement of the operating rod 4 exerts its action continuously, but it may be acceptable for this movement compensation to be exerted only during movements of the operating rod 4.

As used in this disclosure, the term “mount” includes join, unite, connect, associate, insert, hang, hold, affix, attach, fasten, bind, paste, secure, bolt, screw, rivet, solder, weld, and other like terms.

The foregoing description of exemplary embodiments of the invention have been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A drive unit of a device, the drive unit comprising:
a motor;
an operating rod configured for movement under control of the motor;
a nut mounted to the operating rod and configured to allow translational movement of the operating rod with respect to the nut, but not to allow rotational movement of the operating rod with respect to the nut; and
an elastic strip mounted to the nut and configured to mount to a body of a device to exert a rotational torque on the nut.

2. The drive unit of claim 1, further comprising a support ring mounted between the nut and the body of the device.

3. The drive unit of claim 2, wherein the support ring comprises an edge configured to mount in a groove formed in the body of the device.

4. The drive unit of claim 2, wherein the support ring limits translational movement of the nut along a longitudinal axis of the operating rod.

5. The drive unit of claim 1, wherein the elastic strip exerts the rotational torque on the nut in the same direction as stress is imparted on a thread of an internal screw of the motor.

6. The drive unit of claim 1, wherein the elastic strip resists a rotational movement of the nut.

7. The drive unit of claim 1, wherein a first end of the elastic strip is mounted in an aperture formed on a side wall of the nut.

8. The drive unit of claim 1, wherein a second end of the elastic strip is configured to mount to a recess formed in a side wall of the body of the device.

9. A pipette, the pipette comprising:
a body;
a motor mounted within the body;
an operating rod configured for movement under control of the motor;
a nut mounted to the operating rod and configured to allow translational movement of the operating rod with respect to the nut, but not to allow rotational movement of the operating rod with respect to the nut; and
an elastic strip mounted to the nut and to the body to exert a rotational torque on the nut.

10. The pipette of claim 9, further comprising a support ring mounted between the nut and the body.

11. The pipette of claim 10, wherein the support ring comprises an edge mounted in a groove formed in the body.

12. The pipette of claim 10, wherein the support ring limits translational movement of the nut along a longitudinal axis of the operating rod.

13. The pipette of claim 9, wherein the elastic strip exerts the rotational torque on the nut in the same direction as stress is imparted on a thread of an internal screw of the motor.

14. The pipette of claim 9, wherein the elastic strip resists a rotational movement of the nut.

15. The pipette of claim 9, wherein a first end of the elastic strip is mounted in an aperture formed on a side wall of the nut.

16. The pipette of claim 9, wherein a second end of the elastic strip is mounted to a recess formed in a side wall of the body.
